(19) United States
(12) Patent Application Publication
(10) Pub. No.: US 2018/0292675 A1
(43) Pub. Date: Oct. 11, 2018

(54) MAGNETIC EYEWEAR

(71) Applicant: Milner Sports, LLC, Colorado Springs, CO (US)

(72) Inventor: Adam Sandoval, New Richmond, WI (US)

(21) Appl. No.: 15/950,591

(22) Filed: Apr. 11, 2018

Related U.S. Application Data
(60) Provisional application No. 62/484,310, filed on Apr. 11, 2017.

(51) Int. Cl. G02C 5/14

(52) U.S. Cl. CPC G02C 5/143; G02C 2200/02

(57) ABSTRACT

In various embodiments, systems and methods are disclosed for eye wear which contains magnetic material in various portion of the eyewear. A user may remove one pair and the magnetic material will allow it to magnetically couple to a metallic portion of the vehicle or other structure to keep the eyewear from being damaged, broken or lost. The user may the retrieve the eyewear when the user wants to use the eyewear again.

### CROSS REFERENCE TO RELATED APPLICATIONS

This application claims priority to, and benefit from, provisional patent applications Ser. No. 62/484,310, entitled “MAGNETIC EYEWEAR”, filed Apr. 11, 2017, which is incorporated by reference for all purposes.

### BACKGROUND

Many people wear sunglasses and other eyewear during many activities. Some activities include motorcycling, bicycling, etc. “Users may want to switch eyewear while riding or other activity. What is needed is a relatively safe and easy way to switch eyewear while continuing an activity.

### OVERVIEW

In various embodiments, systems and methods are disclosed for eye wear which contains magnetic material in various portion of the eyewear. A user may remove one pair and the magnetic material will allow it to magnetically couple to a metallic portion of the vehicle or other structure to keep the eyewear from being damaged, broken or lost. A second eye wear may be previously magnetically coupled to the metallic surface, such that the user may easily and safely remove them from the coupling with the metallic surface and put them on.

In an embodiment, the eye wear may include a plurality of magnets or some magnetic material, placed at portion of the eye wear to allow for better coupling of the eye wear to the metallic surface, such as the tank of a motorcycle, or a portion of a bicycle, all-terrain vehicle, UTV, etc. A plurality of magnets or a certain amount of magnetic material may be needed for the needed magnetism for a particular metallic surface, activity, or use, etc.

### BRIEF DESCRIPTION OF THE DRAWINGS

FIG. 1 illustrates an example eye wear system including magnetic material.

FIG. 2 illustrates an example eye wear system including magnetic material.

FIG. 3 illustrates eyewear with magnetic material, according to an embodiment.

### DETAILED DESCRIPTION

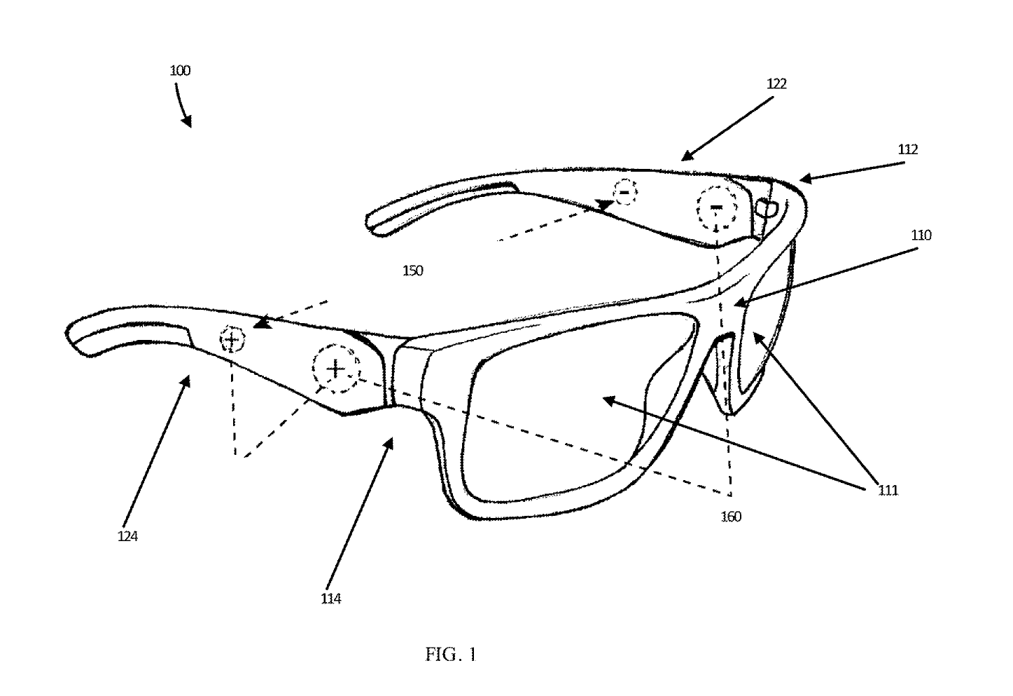

FIGS. 1-3 and the following description depict specific embodiments to teach those skilled in the art how to make and use the invention. For the purpose of teaching inventive principles, some conventional aspects have been simplified or omitted. Those skilled in the art will appreciate variations from these embodiments that fall within the scope of the invention. Those skilled in the art will appreciate that the features described below can be combined in various ways to form multiple embodiments and variations of the invention. As a result, the invention is not limited to the specific embodiments described below, but only by the claims and their equivalents.

FIG. 1 illustrates example eye wear 100. Eyewear 100 includes a frame front 110, lenses 111, bows 122, 124, and magnetic material 150, 160. Frame front 110 has a first end 112 and a second end 114. First bow 122 rotationally couples to first end 112, and second bow 124 rotationally couples to second end 114.

Eyewear 100 also includes magnetic material 150, 160, which may be located adjacent, or within, any portion of eyewear 100. The purpose of magnetic material 150, 160 is to allow for eyewear 100 to magnetically couple to other metallic or magnetic material, such as the tank of a motorcycle, the frame of a bike, a corresponding clip, helmet, glove, jacket, etc. In other embodiments, magnetic material may couple to a magnetic or metallic clip or adaptor (not shown) affixed to a visor of a car, or other surface or system. Furthermore, magnetic material 150, 160 may couple together to hold the eyewear in the closed position.

A user may remove one pair of eyewear 100 and the magnetic material 150, or 160 or both, will allow it to magnetically couple to a metallic portion of the vehicle or other structure to keep the eyewear from being damaged, broken or lost. The user may then put the eyewear 100 back on when needed.

If a user wants to switch eyewear, a first pair may be removed and stored via the magnetic coupling, and a second eye wear (not shown) may be previously magnetically coupled to the metallic surface, such that the user may easily and safely remove them from the coupling with the metallic surface and put the second pair on.

In this example, more than one piece of magnetic material is located adjacent, within, or integral with bows 122 and/or 124. The location, number, or amount of magnetic material may be based on design choices, such as size, weight, and shape of the eyewear, as well as attributes of the metallic or magnetic surface the eyewear is to couple to. Magnetic material 150 may include iron, nickel, cobalt, gadolinium, dysprosium and alloys, or any other system, material or device capable of functioning to couple the eyewear 100 to a vehicle or other location, and/or combinations thereof.

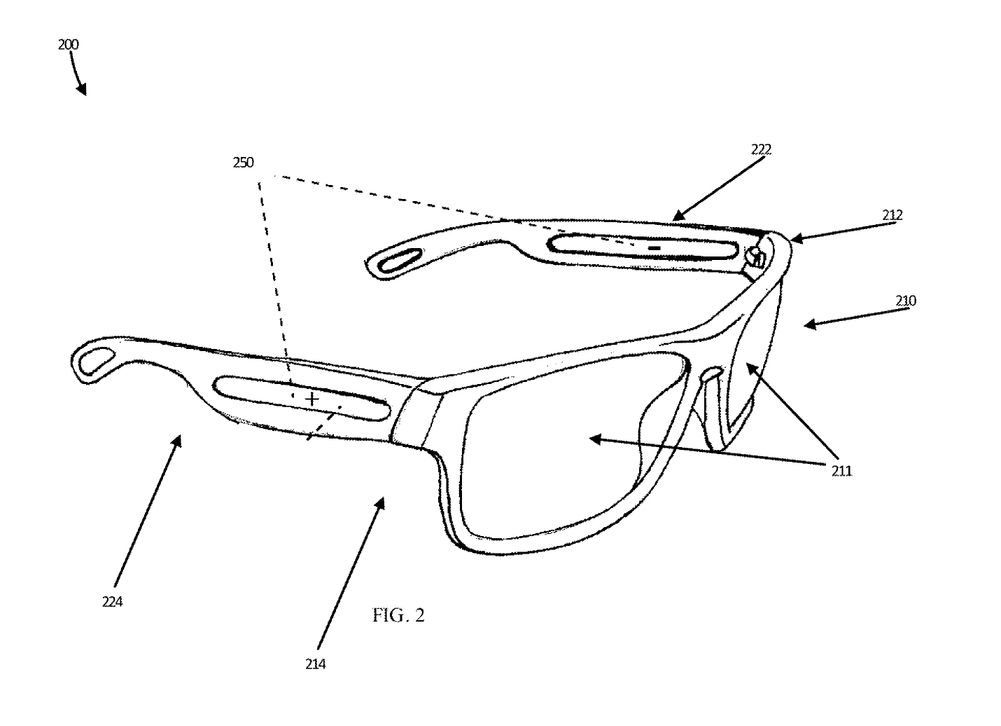

FIG. 2 is an embodiment of eyewear 200. Eyewear 200 includes a frame front 210, lenses 211, bows 222, 224, and magnetic material 250. Frame front 210 has a first end 212 and a second end 214. First bow 222 rotationally couples to first end 212, and second bow 224 rotationally couples to second end 214.

Eyewear 200 also includes magnetic material 250, which may be located adjacent, or within, any portion of eyewear 200. The purpose of magnetic material 250 is to allow for eyewear 200 to magnetically couple to other metallic or magnetic material, such as the tank of a motorcycle, and/or the frame of a bike, and/or the other bow. Alternatively, magnetic material may couple to a magnetic clip or adaptor (not shown) affixed to a visor of a car, or other surface or system.

A user may remove one pair of eyewear 200 and the magnetic material 250 will allow it to magnetically couple to a metallic portion of the vehicle or other structure to keep the eyewear from being damaged, broken or lost. The user may then unstore eyewear 200 back on when needed.

Furthermore, the magnetic material may be located in the frame front, or as an after-market clip coupled adjacent some portion of the eyewear.

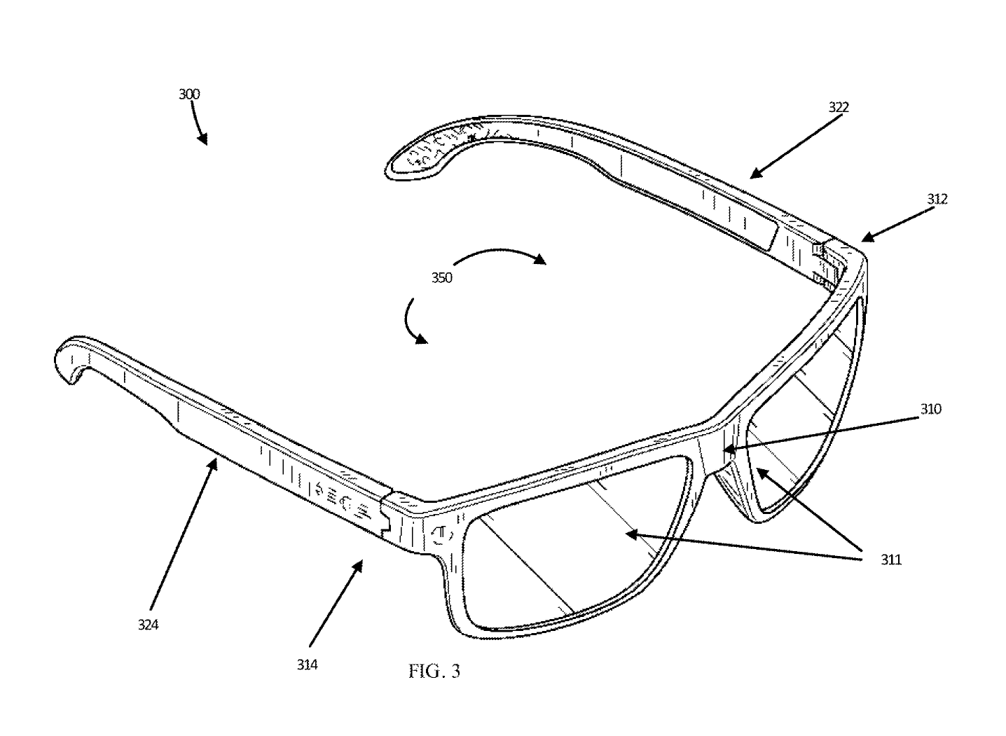

FIG. 3 is an embodiment of eyewear 300. Eyewear 300 includes a frame front 310, lenses 311, bows 322, 324, and magnetic material 350. Frame front 310 has a first end 312 and a second end 314. First bow 322 rotationally couples to first end 312, and second bow 324 rotationally couples to second end 314.

Eyewear 300 also includes magnetic material 350, which may be located adjacent, or within, any portion of eyewear 300. The purpose of magnetic material 350 is to allow for eyewear 200 to magnetically couple to other metallic or magnetic material, such as the tank of a motorcycle, and/or the frame of a bike, and/or the other bow. Alternatively, magnetic material may couple to a magnetic clip or adaptor (not shown) affixed to a visor of a car, or other surface or system.

Although some embodiments have been shown, it will be appreciated that may other styles, configurations, etc. of eyewear are included in the spirit and scope of this disclosure.

It should be understood that many advantages are provided by the systems and methods disclosed herein for eye wear. The above description and associated figures teach various embodiments. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. An eyewear system, comprising:
a frame front comprising a first side and a second side, the frame front configured to receive and hold at least one lens;
a first bow configured to rotationally couple to the first side of the frame front;
a second bow configured to rotationally couple to the second side of the frame front; and
magnetic material adjacent or within the frame front, first bow, and/or second bow configured to allow coupling of the eyewear to a metallic or magnetic surface.

2. The eyewear of claim 1, wherein the metallic or magnetic surface comprises a clip.

3. The eyewear of claim 1, wherein the metallic or magnetic surface is a portion of a vehicle.

4. The eyewear of claim 1, wherein the metallic or magnetic surface comprises a portion of a motorcycle.

5. The eyewear of claim 1, wherein the metallic or magnetic surface comprises a tank of a motorcycle.

6. The eyewear of claim 1, wherein the first and second bow are configured to couple together at least in part via the magnetic material.

7. The eyewear system of claim 1, wherein the magnetic material comprises iron, nickel, cobalt, gadolinium, dysprosium and alloys, and combinations thereof.

8. The eyewear system of claim 1, wherein the magnetic material is coupled to the first bow or second bow near the frame front.

9. A method of creating eyewear capable of coupling to a portion of a vehicle or other surface or system, comprising:
providing a frame front comprising a first end and a second end;
coupling, rotationally, a first bow to the first end of the frame front;
coupling, rotationally, a second bow to the second end of the frame front; and coupling magnetic material adjacent, within, or integral with the first bow, second bow, the frame front, and/or the bow coupling structure;
wherein the magnetic material is designed and configured to magnetically couple the eyewear to a magnetic or metallic surface.

10. The method of claim 9, wherein the metallic or magnetic surface comprises a clip.

11. The method of claim 9, wherein the metallic or magnetic surface is a portion of a vehicle.

12. The method of claim 9, wherein the metallic or magnetic surface comprises a portion of a motorcycle.

13. The eyewear system of claim 9, wherein the magnetic material comprises iron, nickel, cobalt, gadolinium, dysprosium and alloys, and combinations thereof.

14. The eyewear system of claim 9, wherein the magnetic material is coupled to the first bow or second bow near the frame front.

15. The method of claim 9, wherein the first and second bow are configured to couple together at least in part via the magnetic material.

16. An eyewear system, comprising:
a frame front comprising a first side and a second side, the frame front configured to receive and hold at least one lens;
a first bow configured to rotationally couple to the first side of the frame front;
a second bow configured to rotationally couple to the second side of the frame front; and
magnetic material the first bow, and second bow configured to allow coupling of the eyewear to a metallic or magnetic surface,
wherein the wherein the metallic or magnetic surface comprises a tank of a motorcycle,
wherein the first and second bow are configured to couple together at least in part via the magnetic material.

17. The eyewear system of claim 16, wherein the magnetic material comprises iron, nickel, cobalt, gadolinium, dysprosium and alloys, and combinations thereof.

18. The eyewear system of claim 17, wherein the magnetic material is coupled to the first bow or second bow near the frame front.
